(19) United States
(12) Patent Application Publication
(10) Pub. No.: US 2006/0056075 A1
(43) Pub. Date: Mar. 16, 2006

(54) Dual power binocular with adjustable stop

(76) Inventors: Ellis I Betensky, Halifax (CA); James Brian Caldwell, Petersburg, VA (US); Klaus G Raschke, Weston, FL (US)

Correspondence Address: MAURICE M KLEE, 1951 BURR STREET, FAIRFIELD, CT, 06824, US

(21) Appl. No.: 10/501,846

(22) PCT Filed: Dec. 23, 2002
(86) PCT No.: PCT/US02/41525

§ 371 Date: Jun. 27, 2005

Related U.S. Application Data
(60) Provisional application No. 60/343,662, filed on Dec. 26, 2001.

(51) Int. Cl. G02B 27/02

(52) U.S. Cl. 359/800

(57) ABSTRACT

A dual power binocular (13) is provided which can be rapidly switched between a low magnification setting (wider field of view) and a high magnification setting (narrower field of view). Preferably, the switching is performed using a switch (17) mounted on, for example, the bridge (11) of the binocular (13). Each barrel (9) of the binocular includes an adjustable aperture stop. Preferably, the adjustable aperture stop is behind the binocular's objective (19), i.e., on the exepiece (21) side of the objective (19). Most preferably, the adjustable aperture stop is a moveable aperture assembly (31) which restricts light passing through the binocular in the low magnification setting but not in the high magnification setting. Through the use of an adjustable aperture stop, the diameter of the exit pupil and thus the brightness of the imager perceived by the user is substantially the same for the two magnification settings.

### CROSS REFERENCE TO RELATED PROVISIONAL APPLICATION

This application claims the benefit under 35 USC §119(e) of U.S. Provisional Application No. 60/343,662, filed Dec. 26, 2001, the contents of which are incorporated herein in their entirety.

### FIELD OF THE INVENTION

This invention relates to dual power binoculars and, in particular, as set forth below, to dual power binoculars which have an adjustable stop and thus a substantially constant brightness.

### BACKGROUND OF THE INVENTION

U.S. Pat. Nos. 5,371,626, 5,500,769, 5,532,875, and 5,499,140 to Ellis I. Betensky, the contents of which are incorporated herein by reference, disclose dual power binoculars having a construction which allows for rapid switching between the binocular's low magnification (wider field of view) and high magnification (narrower field of view) positions. In the description that follows, the invention is illustrated with reference to a binocular having the basic structure, i.e., fixed and moveable units, of these patents, it being understood that the invention is also applicable to dual power binoculars having other constructions.

When a dual power binocular with a non-adjustable aperture stop, e.g., an aperture stop defined by the binocular's objective, is switched from its low magnification position (e.g., its 5× position) to its high magnification position (e.g., its 10× position), a substantial change occurs in diameter of the binocular's exit pupil and thus in the brightness of the image seen by the user. In particular, the binocular's exit pupil will decrease in size by an amount equal to the ratio of the binocular's low magnification to its high magnification.

For example, as illustrated below, in accordance with certain aspects of the invention, the diameter of the exit pupil is kept at a value of about 3 millimeters or less to allow for a high quality image without an unduly complex (and thus expensive) optical system. If a binocular with a non-adjustable aperture stop had such an exit pupil in its low magnification position, then it would have an exit pupil whose diameter was only 1.5 millimeters in its high magnification position, assuming a 2:1 (e.g., 10× to 5×) dual power binocular. Such a reduction in exit pupil size and thus brightness is both noticeable and bothersome to the user, especially in a dual power binocular which is capable of rapid switching between its two magnifications, as is preferred. In contrast, a zoom binocular moves relatively slowly through its range of magnifications and thus reductions in brightness with higher levels of magnification are not as noticeable or bothersome to the user.

Look at another way, the size of the exit pupil could be selected for the high magnification position and allowed to become larger in the low magnification position. However, in a low cost binocular this presents a problem because it is very difficult to correct the aberrations at the low magnification position when the pupil size increases. One way of addressing this problem is to use a small pupil in the high magnification position, e.g., an exit pupil size (diameter) of 1.5 millimeters as discussed above. However, this alternative is not very attractive because the binocular will not perform well in low light at the high magnification position and the change in brightness between the low and high magnifications will be evident to the user.

The present invention addresses this problem of brightness variation between the low and high magnification positions of a dual power binocular and provides optical and mechanical systems which solve the problem and which can be readily manufactured in large quantities and at low cost.

### SUMMARY OF THE INVENTION

In accordance with a first aspect, the invention provides an optical system which transmits light and has first and second settings, the first setting providing a magnification M₁ and the second setting providing a magnification M₂, wherein:

(i) M₂/M₁>1.0;

(ii) the system has an exit pupil which has a diameter D₁ for the first setting and a diameter D₂ for the second setting;

(iii) D₁ and D₂ are substantially the same (e.g., 1.0<D₁/D₂<1.5); and

(iv) the first and second settings are the only rest positions of the optical system.

In accordance with a second aspect, the invention provides an optical system which transmits light and has first and second settings, the first setting providing a magnification M₁ and the second setting providing a magnification M₂, wherein:

(i) M₂/M₁>1.0;

(ii) the first and second settings are the only rest positions of the optical system; and

(iii) the system comprises a two position aperture stop which restricts more light when the system is in the first setting than when the system is in the second setting.

In certain preferred embodiments of this aspect of the invention, the optical system comprises an objective and an eyepiece and the two position aperture stop is located between the objective and the eyepiece and is closer to the objective than to the eyepiece.

In accordance with a third aspect, the invention provides an optical system which transmits light and comprises:

(a) an aperture assembly comprising an aperture, the assembly having two orientations in one of which the aperture restricts the amount of light transmitted through the optical system (the light-restricting orientation) and in the other of which it does not restrict the amount of light transmitted through the optical system (the non-light restricting orientation);

(b) a first mechanism which moves the aperture assembly between the light-restricting and the non-light restricting orientations, the first mechanism having a path of motion which includes a first rest position corresponding to the light-restricting orientation and a second rest position corresponding to the non-light restricting orientation;

(c) a second mechanism comprising a spring (e.g., over-the-center spring 73) which (1) is adapted to bias the first mechanism into either the first rest position or the second rest position, (2) causes the first mechanism to automatically switch to the first rest position once the first mechanism has moved past a first position along its path of motion, and (3) causes the first mechanism to automatically switch to the second rest position once the first mechanism has moved past a second position along its path of motion; and

(d) a third mechanism (e.g., toggle switch 17, force transfer member 62, and aperture 71) which:

(i) when the first mechanism is in its first rest position, is adapted to move the first mechanism between the first rest position and the second position; and

(ii) when the first mechanism is in its second rest position, is adapted to move the first mechanism between the second rest position and the first position.

In accordance with a fourth aspect, the invention provides an optical system which transmits light comprising:

(a) a lens assembly (e.g., objective 19) which transmits light;

(b) a focusing system for moving the lens assembly to focus the optical system;

(c) an aperture assembly which receives light from the lens assembly, the aperture assembly comprising an aperture having two orientations in one of which the aperture restricts light transmission (the light-restricting orientation) and in the other of which it does not restrict light transmission (the non-light restricting orientation); and

(d) an aperture drive mechanism (e.g., the first, second, and third mechanisms of the third aspect of the invention) for transferring the aperture assembly between the two orientations;

wherein when the focusing system moves the lens assembly, it also moves the aperture assembly but does not change the aperture assembly's orientation.

In certain preferred embodiments of this aspect of the invention, the aperture drive mechanism comprises a moveable member (e.g., member 41) which allows the aperture assembly to maintain its orientation as the focusing system moves the lens and aperture assemblies.

In other preferred embodiments, the aperture assembly comprises at least one groove (e.g., groove 53) and the moveable member comprises at least one pin (e.g., pin 55) which moves in the at least one groove.

In still further preferred embodiments, the optical system further comprises a housing (e.g., objective housing 29) which comprises at least one ramp (e.g., ramp 57) which engages the moveable member (e.g., engages pin 55 of member 41) and guides that member so as to move the aperture assembly from the non-light restricting orientation to the light-restricting orientation as the aperture drive mechanism transfers the aperture assembly between those two orientations.

In accordance with a fifth aspect, the invention provides an optical system which transmits light comprising:

(a) an aperture assembly comprising an aperture, the assembly having two orientations in one of which the aperture restricts the amount of light transmitted through the optical system (the light-restricting orientation) and in the other of which it does not restrict the amount of light transmitted through the optical system (the non-light restricting orientation); and

(b) an aperture drive mechanism (e.g., the first, second, and third mechanisms of the third aspect of the invention) for transferring the aperture assembly between the two orientations, the mechanism comprising a spring (e.g., torsion spring 59) which, when the aperture assembly is in the light-restricting orientation, biases the aperture assembly towards the light-restricting orientation, and when the aperture assembly is in the non-light restricting orientation, biases the aperture assembly towards the non-light restricting orientation.

In accordance with a sixth aspect, the invention provides an optical system which transmits light comprising:

(a) an aperture assembly comprising an aperture, the assembly having two orientations in one of which the aperture restricts the amount of light transmitted through the optical system (the light-restricting orientation) and in the other of which it does not restrict the amount of light transmitted through the optical system (the non-light restricting orientation);

(b) an aperture drive mechanism (e.g., the first, second, and third mechanisms of the third aspect of the invention) for transferring the aperture assembly between the two orientations, the aperture drive mechanism having a first rest position corresponding to the light restricting orientation and a second rest position corresponding to the non-light restricting orientation; and

a housing (e.g., objective housing 29) which comprises at least one ramp (e.g., ramp 57) which engages the aperture drive mechanism so as to guide the aperture assembly from the non-light restricting orientation to the light-restricting orientation as the aperture drive mechanism moves from its second rest position to its first rest position.

In certain preferred embodiments of this aspect of the invention, the ramp is stepped.

In accordance with a seventh aspect, the invention provides an optical system which transmits light, the system having an exit pupil and comprising:

(a) a lens assembly (e.g., objective 19) which transmits light;

(b) a focusing system for moving the lens assembly to focus the optical system; and

(c) an aperture assembly which receives light from the lens assembly, the assembly having two settings which differ in the amount of restriction they provide for light transmitted through the optical system;

wherein when the focusing system moves the lens assembly, it also moves the aperture assembly so that the size of the exit pupil of the optical system remains substantially constant during focusing.

In accordance with an eighth aspect, the invention provides a method for switching an optical system between a lower magnification setting and a higher magnification setting comprising:

(a) providing a switching mechanism having a first rest position corresponding to the lower magnification setting and a second rest position corresponding to the higher magnification setting, the switching mechanism having a path of motion between the first and second rest positions; and

(b) providing automatic switching to the first rest position once the switching mechanism has moved past a first position along its path of motion and automatic switching to the second rest position once the switching mechanism has moved past a second position along its path of motion.

In certain preferred embodiments of this aspect of the invention, the automatic switching is provided by a torsion spring (e.g., over-the-center spring 73).

In accordance with each of the foregoing aspects of the invention, the optical system preferably has two magnifications (M₁ and M₂) and two corresponding exit pupil diameters (D₁ and D2) which satisfy at least one of the following relationships and preferably all of these relationships:
M₂/M₁>1.5; and/or
(D₁·M₁)/(D₂·M₂)<1.0; and/or
(D₁·M₁)/(D₂·M₂)<0.75.

For example, for the prescriptions set forth below, M₂/M₁ is approximately 2 (e.g., M₂/M₁=1.9) and (D₁·M₁)/(D₂·M₂) is approximately 0.6 (e.g., (D₁·M₁)/(D₂·M₂)=0.63).

The parenthetical references used in the above summaries of the various aspects of the invention are only for the convenience of the reader and are not intended to and should not be interpreted as limiting the scope of the invention. More generally, it is to be understood that both the foregoing general description and the following detailed description are merely exemplary of the invention, and are intended to provide an overview or framework for understanding the nature and character of the invention. Further, it is to be understood that the above aspects of the invention, including the various preferred embodiments thereof, can be used alone or in any and all combinations thereof, as desired.

Additional features and advantages of the invention are set forth in the detailed description which follows, and in part will be readily apparent to those skilled in the art from that description or recognized by practicing the invention as described herein. The accompanying drawings are included to provide a further understanding of the invention, and are incorporated in and constitute a part of this specification.

### BRIEF DESCRIPTION OF THE DRAWINGS

FIGS. 1A and 1B are schematic side views of an optical system constructed in accordance with the invention in its low and high magnification positions, respectively. This embodiment employs an aspheric lens surface in eye lens unit 21.

FIGS. 2A and 2B are schematic side views of an optical system constructed in accordance with the invention in its low and high magnification positions, respectively. This embodiment employs only spherical lens surfaces.

FIG. 3 is a perspective view of a binocular constructed in accordance with the invention.

FIGS. 4-10 illustrate various of the mechanical aspects of the binocular of FIG. 3. In these figures, components of the overall binocular which are not necessary for an understanding of the mechanism being illustrated have been removed for clarity. Also, except for FIGS. 3, 4, and 9, the components of only one side (e.g., one barrel) of the binocular are shown, again for purposes of clarity, it being understood that the functions and configurations illustrated apply to both sides of the binocular and occur simultaneously for the two sides. In particular, the construction of the side of the binocular which will be on the user's right hand side during use is shown in FIGS. 5-8 and 10.

FIG. 4 is a perspective view of a focusing mechanism.

FIGS. 5A and 5C are cross-sectional views and FIG. 5B is a perspective view of a housing (the objective housing) which carries a moveable aperture assembly and an objective (e.g., an objective lens group).

FIGS. 6A and 6B are cross-sectional views showing light-restricting and non-light restricting orientations of the moveable aperture assembly of FIG. 5 relative to the objective housing for a low magnification setting (FIG. 6A) and a high magnification setting (FIG. 6B) of the binocular.

FIGS. 7A and 7B are perspective views showing a first mechanism (first mechanical mechanism) of a drive system for the moveable aperture assembly in its low magnification (FIG. 7A) and high magnification (FIG. 7B) rest positions.

FIGS. 8A and 8B are perspective views showing a second mechanism (second mechanical mechanism) of a drive system for the moveable aperture assembly in its low magnification (FIG. 8A) and high magnification (FIG. 8B) rest positions. FIG. 8C is an end view of the second mechanism in its high magnification rest position. The second mechanism's use of a moveable over-the-center spring is illustrated in these figures.

FIGS. 9A and 9B illustrate a third mechanism (third mechanical mechanism) of a drive system for the moveable aperture assembly in its low magnification (FIG. 9A) and high magnification rest positions (FIG. 9B).

FIGS. 10A and 10B illustrate the ability of the moveable aperture assembly to maintain its light-restricting orientation and its location relative to the optical system's objective as the objective housing is moved to focus the binocular. The maintenance of this orientation and location is important since it avoids variations in the brightness of the image during focusing of the binocular in its low magnification setting. FIG. 10A shows the objective housing in a position suitable for focusing on a distance object, while FIG. 10B shows the housing position for a nearer object. As can be seen in these figures, the distance between the objective housing and the binocular's eyepiece is less in FIG. 10A than in FIG. 10B. In both positions, the moveable aperture assembly remains in contact with the objective housing's diaphragm.

FIGS. 11A and 11B illustrate another embodiment of a adjustable aperture stop, specifically, a two position aperture stop, in its low magnification (FIG. 11A) and high magnification (FIG. 11B) configurations.

In the above drawings, like reference numbers designate like or corresponding parts throughout the several views. The elements to which the reference numbers generally correspond are set forth in Table 3.

### DETAILED DESCRIPTION OF THE INVENTION

A. Optical Aspects

As discussed above, the present invention addresses the problem of variation in brightness as a dual power binocular is switched between its high and low magnification settings. In particular, the invention provides optical systems in which the exit pupil size (diameter) is nearly the same at both magnification settings, e.g., the ratio of the maximum exit pupil size to the minimum exit pupil size is preferably less than 1.5, more preferably less than 1.4, and most preferably less than 1.3, e.g., approximately 1.2.

In accordance with the invention, this is achieved by stopping down the system at the low magnification setting. There are only two places where this can be done. One is at the exit pupil. This is not practical because the user needs to put his or her eye at the exit pupil. Although the user's eye will stop down the system in bright light, a binocular is often used in dim light and should provide excellent image quality both when used in bright light and under darker conditions.

The other potential stop location is at the plane which is conjugate to the exit pupil. For the low magnification position and a binocular of the type disclosed in the above-referenced Betensky patents, this plane is located near the objective, and its position changes fairly dramatically (moves towards the eyepiece) as the magnification is changed to the high magnification position. Moreover, this plane is located well in front of the objective when in the low magnification mode for most of the prescriptions of the Betensky patents. This is not a preferred location for a stop because it makes the system longer than necessary.

Accordingly, one of the features of the dual power binocular of the present invention is that for its low magnification position, the binocular has a stop that is intentionally located just behind the objective. In particular, the location of the aperture stop is constrained to be behind the objective (i.e., on the exit pupil side of the objective) as the lens is optimized using a lens design program, such as the ZEMAX program sold by Focus Software Inc. of Tucson, Ariz.

Subject to this constraint, the optical components behind the stop are selected and positioned to ensure that when the binocular is in the low magnification position, the stop plane and the exit pupil are conjugate to each other. If this condition is not met, severe vignetting will occur when the system is stopped down to control the exit pupil diameter at the low magnification position.

In addition to reducing the overall length of the system, the incorporation of an adjustable aperture stop into the system, rather than using a non-adjustable aperture stop, specifically, the binocular's objective as the aperture stop, allows for the use of a larger objective. This can be seen by considering the size of the objective for a 3 millimeter exit pupil diameter. For the binocular's objective as a non-adjustable aperture stop and a low magnification of 5×, an exit pupil of 3 millimeters corresponds to an objective whose diameter is 15 millimeters. In contrast, as illustrated by the examples presented below, the binocular of the invention with an adjustable aperture stop can have an objective whose diameter is, for example, 25 millimeters. This diameter is utilized in the high magnification position and maximizes the brightness of the image in that mode, which is especially important in low light (e.g., dull weather) conditions. Less than the full diameter of the objective is used in the low magnification position, but because in that position the exit pupil as established by the variable aperture stop has a diameter of 3 millimeters, the image provided to the user is also bright even under low light conditions. Objectives having diameters larger or smaller than 25 millimeters can, of course, be used in the practice of the invention.

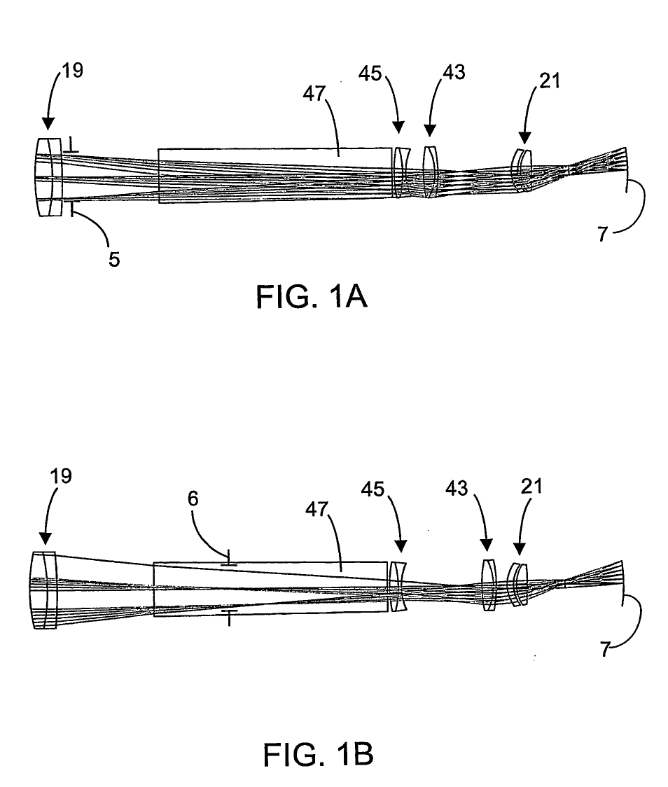

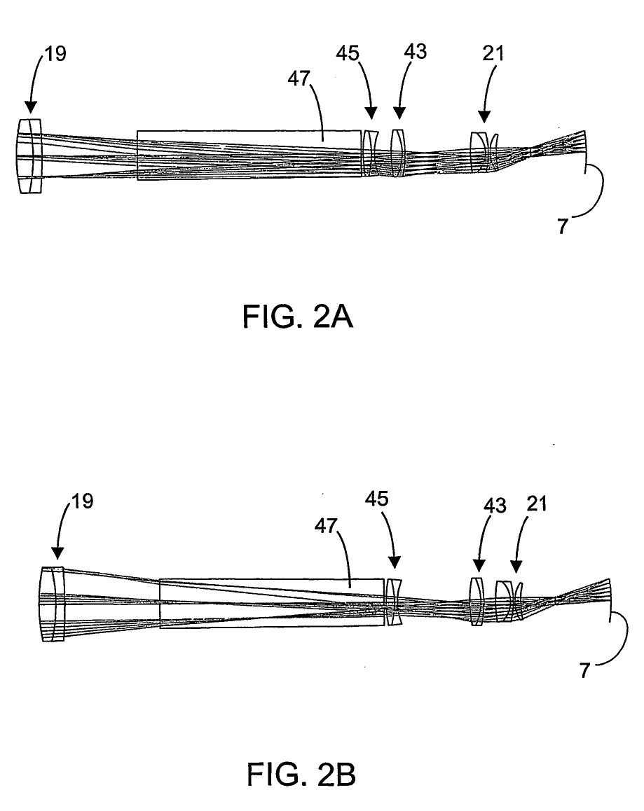

FIG. 1 shows a preferred form of a dual-power binocular system constructed in accordance with the invention. In particular, FIG. 1A shows the system in its low magnification position, while FIG. 1B shows the high magnification position. Corresponding prescriptions in ZEMAX format for two embodiments having the configuration shown in FIG. 1 are set forth in Tables 1-1 and 1-2. FIG. 2 and Table 2 shows an alternate embodiment in which all of the lens elements have spherical surfaces. All dimensions in Tables 1-1, 1-2, and 2 are in millimeters. The prescription of Table 1-2 is currently considered the preferred prescription for the dual power binoculars of the invention.

The prescriptions of Tables 1-1, 1-2, and 2 assume an eye relief of 12 millimeters and limit the size of the exit pupil in the low magnification position to 3 millimeters. As discussed in more detail below, functionally, the diameter of the exit pupil at the high magnification position is determined by the clear aperture of the objective and is approximately 2.5 millimeters. The ratio of the maximum exit pupil size to the minimum exit pupil size is thus 1.2. The surface labeled STO in these prescriptions is a paraxial lens at the stop location with a focal length of 18.75 millimeters for Tables 1-1 and 2 and a focal length of 10 millimeters for Table 1-2. It is included in the prescription to simulate the optics of the user's eye.

It should be noted that the binocular of the invention, as exemplified in Tables 1-1, 1-2, and 2, preferably employs color correction in each of the lens units located on the object side of the binocular's eye lens unit. This produces an overall balanced design which is less sensitive to changes in magnification. In particular, the binocular preferably uses a doublet as the moving unit to change the magnification of the binocular. As illustrated by the prescriptions of Tables 1-1 and 1-2, the eye lens unit of the binocular preferably includes one aspheric surface on a lens element made of plastic, e.g., PMMA. Alternatively, as illustrated by the prescription of Table 2, the system can include only spherical surfaces. In general, the use of at least one aspheric surface is preferred. The aspheric surface can be a conic surface as illustrated in Tables 1-1 and 1-2 or a general asphere if desired.

Overall, the binocular of the invention achieves excellent optical performance with a minimum of lens elements, e.g., a total of only eight lens elements for the embodiments of Tables 1-1 and 1-2, with six of the elements being in the form of doublets which facilitates their assembly into the finished binocular. For comparison, a fixed focus binocular has at least five lens elements, and thus, the binocular of the invention in its preferred embodiments achieves dual power with the addition of only three elements.

A dual power binocular with even less elements can be achieved by including one or more diffractive surfaces in the binocular. For example, the doublet of the objective can be replaced with a positive element having a diffractive formed on or applied to one of its surfaces. Similar replacements can be made for others (including all) of the remaining doublets of the system. Along the same lines, the two lens elements of the eye lens unit can be replaced with a single element having an aspheric surface and a diffractive surface. Indeed, the diffractive surface can itself function as an aspheric surface, whereby the eye lens unit can consist of a single element having a refractive surface on one side and a diffractive/aspheric surface on the other side.

The calculated locations (5, 6) of the aperture stop for the low and high magnification positions for the prescription of Table 1-1 are shown in FIGS. 1A and 1B, respectively. In each case, the aperture stop is located at the plane conjugate to the exit pupil of the system. A comparison of the two panels of this figure shows that the plane conjugate to the exit pupil shifts substantially between the two magnification positions.

It is important to note that a physical aperture stop is only needed at the location of the plane conjugate to the exit pupil for the low magnification position. This is because in accordance with the invention, for the high magnification position, the objective (or its mounting ring) performs the function of an aperture stop. Specifically, to avoid an excessively large objective, the clear aperture of the objective is chosen to be smaller than that needed to avoid vignetting of off-axis light. This can be done without producing a dim image since for the high magnification position, the field of view is small and thus the amount of light entering the objective at steep angles is small. The use of a clear aperture of reduced size for the objective limits the size of the axial beam which can pass through the system, thus causing the objective to function as the aperture stop.

Because the binocular of the invention only uses a physical aperture stop at the location of the plane conjugate to the exit pupil for the low magnification position, the overall construction of the binocular can be simplified, which is an important advantage of the invention. Moreover, the physical aperture stop itself can have a simplified construction since it only needs to go from being present when the binocular is in its low magnification position to being absent when the binocular is in its high magnification position. In particular, an iris with multiple settings is not required for the physical aperture stop, which reduces the cost of the binocular. Although a physical aperture stop with as simple a construction as possible is preferred, more complex constructions can be used in the practice of the invention if desired.

Examples of suitable aperture mechanisms for use in the practice of the invention are set forth below in connection with the discussion of the mechanical aspects of the invention.

To summarize the optical aspects of the invention, as shown by the foregoing, the benefits of the preferred embodiments of those aspects include:

(1) excellent optical performance at both the high and low magnification positions through the use of a physical aperture stop for the low magnification position that limits the size of the exit pupil at that magnification;

(2) the ability to use an aperture stop which is mechanically much simpler than a complex and bulky iris diaphragm, which reduces the size and cost of the binocular;

(3) a larger objective than a corresponding binocular which uses the objective as a non-adjustable aperture stop; and/or

(4) an image brightness that remains relatively constant as the binocular is switched between its low and high magnification positions.

B. Mechanical Aspects

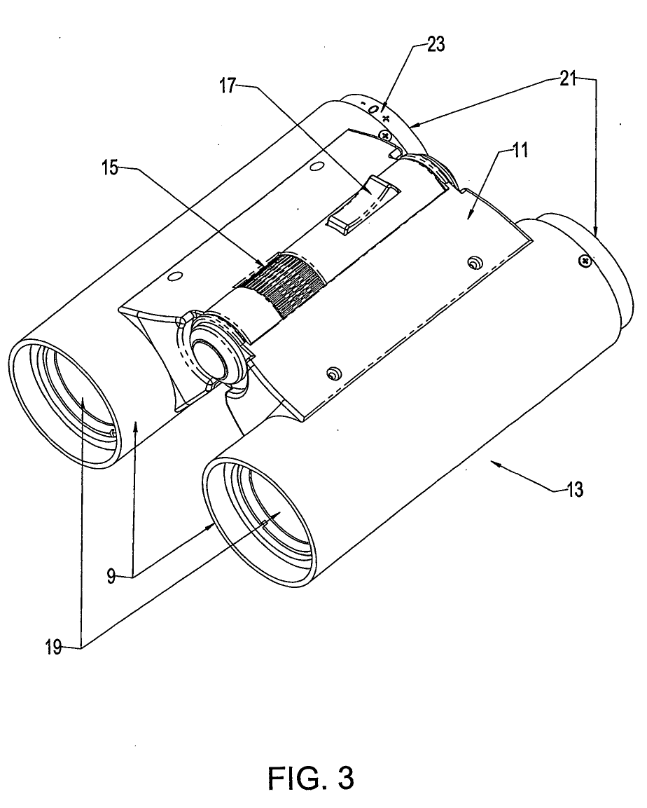

Particularly preferred mechanisms for providing an adjustable aperture stop are shown in FIGS. 3-10. In broad outline, these figures show an adjustable aperture stop which comprises a physical aperture stop which preferably has a constant diameter and which is moved into and out of the optical path of the light transmitting optical system whose aperture is to be adjusted. These figures show the application of the mechanical aspects of the invention to a binocular system, it being understood that the these aspects can be used in a variety of other optical systems which transmit light.

FIG. 3 shows the exterior configuration of a binocular 13 constructed in accordance with the invention. The binocular has two barrels 9 connected by a bridge 11. The bridge carries a thumb wheel 15 for adjusting the focus of the binocular and a toggle switch 17 for changing the magnification of the binocular between a low magnification and a high magnification setting. Each of the barrels has an objective 19 at one end and an eyepiece 21 at the other. As is conventional, one of the eyepieces includes a diopter adjustment 23.

Although toggle switch 17 is shown on the top of bridge 11, this switch can be located elsewhere on the binocular. For example, it can be located on a bottom surface of the binocular's bridge or can be on either the top or the bottom of one the barrels. Further, although shown as a single toggle switch, the actuation mechanism for changing the magnification of the binocular can employ more than one toggle switch and/or one or more buttons, slides, or similar devices. As will be discussed below, the magnification switching mechanism is preferably manually driven, but electrically operated mechanisms (e.g., battery powered mechanisms) can be used if desired. Similarly, the focusing mechanism discussed next is preferably a manual system, but can be electrical (e.g., battery powered) if desired. For example, a battery powered auto-focus system can be used in the practice of the invention.

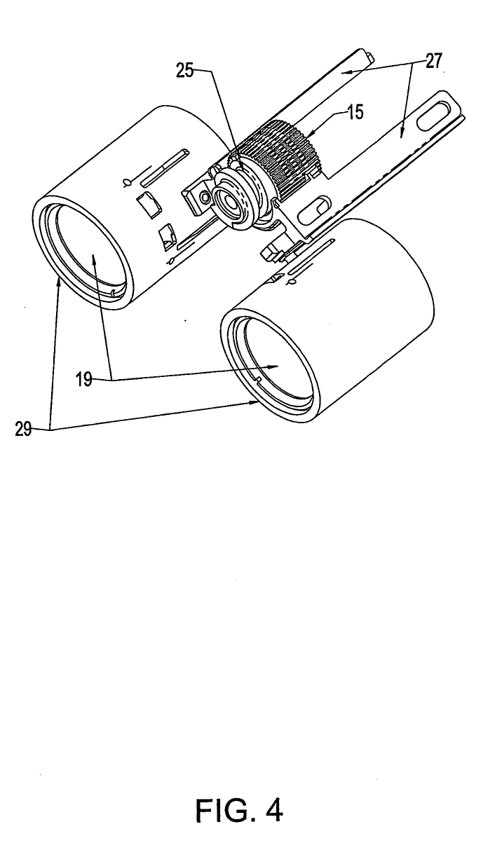

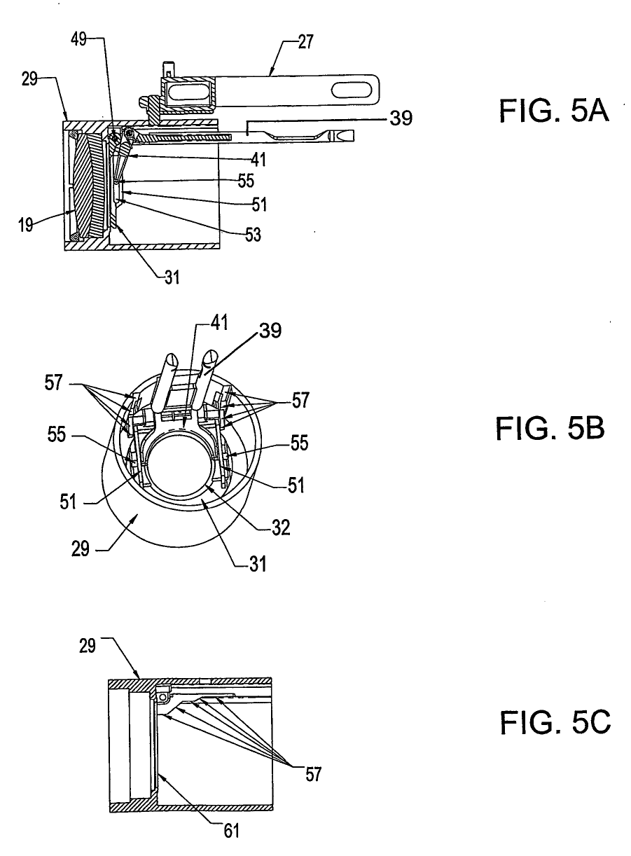

FIG. 4 illustrates the operation of the focusing thumb wheel 15 of FIG. 1. More generally, FIG. 4 illustrates one embodiment of a drive mechanism (focusing system) for moving the objective lens assembly of the binocular. As shown in this figure, thumb wheel 15 includes a spiral cam 25 which is connected to and produces linear motion of rails 27, one rail being associated with each of the binocular's two barrels. Rails 27 are, in turn, connected to objective housings 29 which move within the outer housings of the binocular's two barrels.

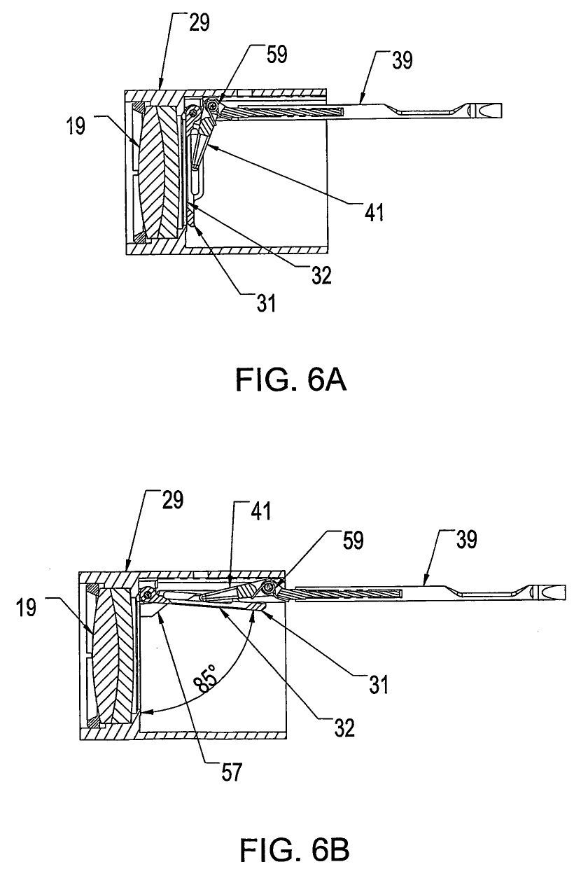

As shown in FIGS. 5A, 5B, and 5C, objective housing 29 carries objective 19 (e.g., a doublet), as well as moveable aperture assembly 31 (see discussion below). Linear motion of rails 27 causes linear motion of the objective housing and thus linear motion of objective 19 which changes the focus of the binocular. It is to be understood that the mechanism of FIGS. 4 and 5 is merely one example of a drive mechanism for moving a lens assembly and a variety of other mechanisms can be used in the practice of the invention.

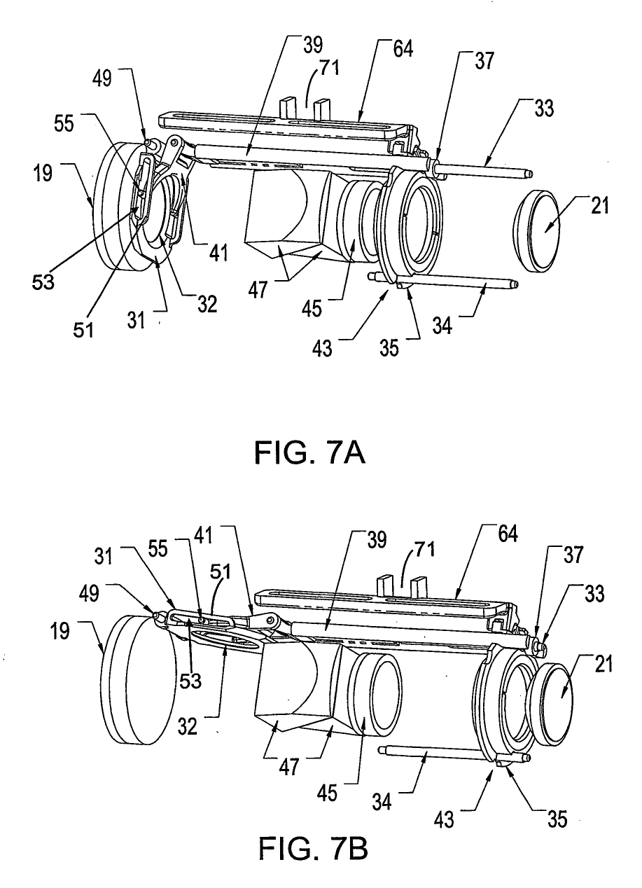

FIGS. 6A and 6B show the orientations of moveable aperture assembly 31 relative to objective housing 29 for the low magnification and high magnification settings of the binocular, respectively. As can be seen most clearly in FIG. 5B, aperture assembly 31 includes aperture 32 whose diameter is determined in accordance with the optical aspects of the invention discussed above.

As can be seen in FIGS. 6A and 6B, aperture assembly 31 is in the optical path through the binocular for the low magnification setting (FIG. 6A) and is out of the optical path for the high magnification setting (FIG. 6B). Thus, in the low magnification setting, the aperture assembly restricts the amount of light transmitted through the optical system (the light-restricting orientation), while in the high magnification setting the aperture assembly does not restrict the amount of light transmitted through the optical system (the non-light restricting orientation). As can also be seen in these figures, the light-restricting and the non-light restricting orientations of the aperture assembly are substantially perpendicular to one another (e.g., the angle between the orientations is preferably greater than about 80°, e.g., most preferably about 85°).

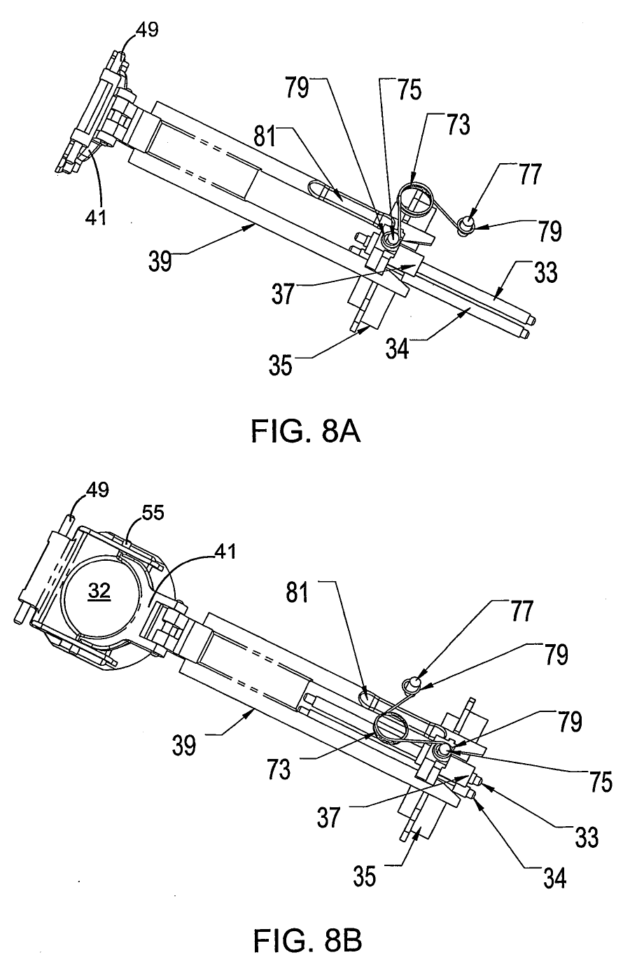

In accordance with the preferred embodiments of the invention, aperture assembly 31 is transferred between its light-restricting and non-light restricting orientations using a drive system (also referred to herein as an “aperture drive mechanism”) which preferably is composed of first, second, and third mechanisms, examples of which are shown in FIGS. 7, 8, and 9, respectively.

FIG. 7 shows the first mechanism of the drive system for moveable aperture assembly 31 in its low magnification (FIG. 7A) and high magnification (FIG. 7B) rest positions (i.e., its first and second rest positions). This mechanism comprises: guide shaft 33, lens carrier 35 which includes bushing 37, input coupler 64, transport slide 39, and moveable member 41. Lens carrier 35 transports moveable lens assembly 43, whose movement changes the magnification of the binocular.

It should be noted that although lens carrier 35, bushing 37, input coupler 64, and transport slide 39 are shown as separate components, one or more of these components can be combined into a single part, and, indeed, all of the components can be made as a single part if desired. More generally, the configurations of the components shown in the figures represent presently preferred configurations and should not be interpreted as limiting the scope of the invention in any way.) However made, lens carrier 35, bushing 37, input coupler 64, and transport slide 39 need to be rigidly connected to one another so that they can move moveable lens assembly 43 and aperture assembly 31 in synchrony.

Also shown in FIG. 7 is objective 19 and eyepiece 21, as well as intermediate lens element 45 and prism 47 (e.g., a Porro or Pechan prism, a Pechan prism being shown in the figures). Each of these components remains fixed during transfer of the optical system between its low magnification and high magnification rest positions and thus the operation of the first mechanism can be most easily understood by comparing the locations of the moveable components of that mechanism to these fixed elements in FIGS. 7A and 7B.

In particular, as can be seen in these figures, as the first mechanism moves from its low magnification rest position (FIG. 7A) to its high magnification rest position (FIG. 7B), bushing 37 slides along guide shaft 33 from left to right in the figures. Lens carrier 35 has a U-shaped aperture opposite to bushing 37 which rides on shaft 34 and serves to avoid rotation of the lens carrier about shaft 33.

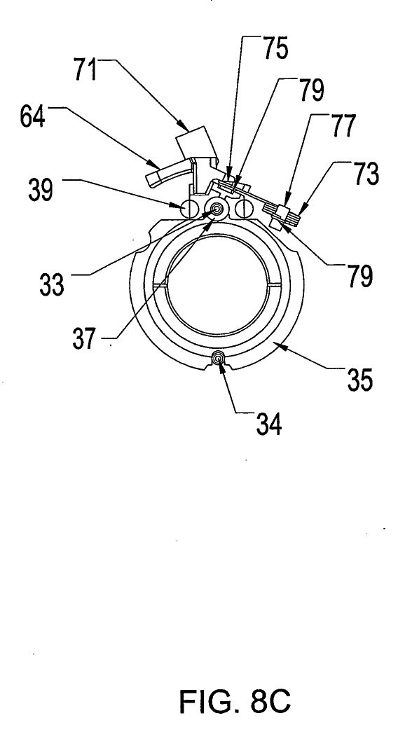

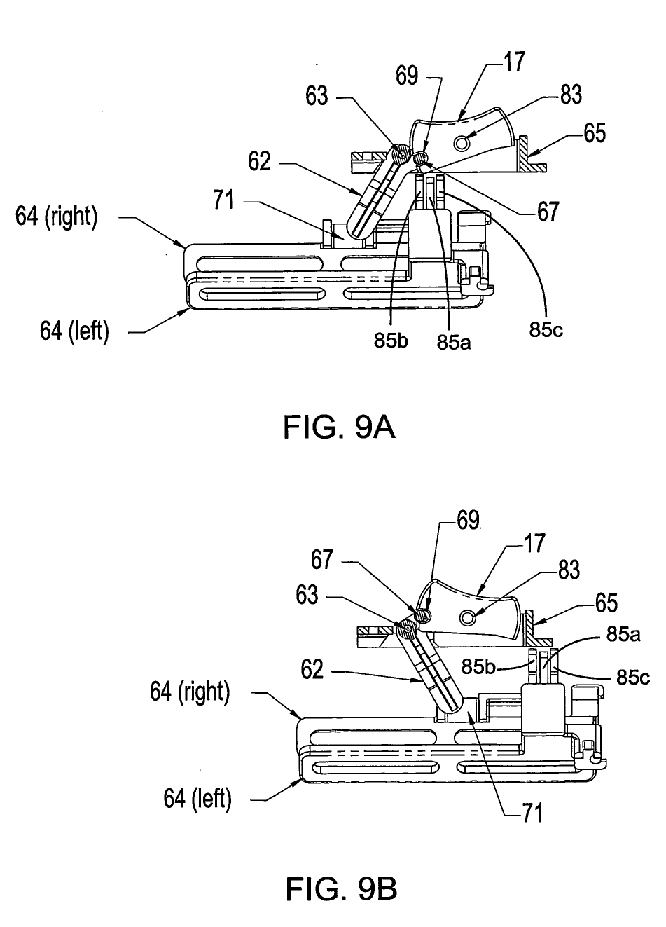

The forces which produce the left-to-right movement of bushing 37 are discussed below in connection with FIGS. 8 and 9. For now, we will discuss how the left-to-right movement of FIG. 7 causes aperture assembly 31 to switch from its light-restricting orientation (FIG. 7A) to its non-light restricting orientation (FIG. 7B).

As shown most clearly in FIG. 5A, aperture assembly 31 is rotatably mounted on pin 49 which is affixed to objective housing 29. As also shown in this figure, aperture assembly 31 includes rails 51 which form grooves 53 which mate with pins 55 on moveable member 41 of the first mechanism. As a result of this structure, as transport slide 39 and moveable member 41 move from left-to-right in FIG. 7, pins 55 move to the right in grooves 53 and through their contact with rails 51 pull aperture assembly 31 into its non-light restricting orientation of FIG. 7B.

To provide reliable transfer of aperture assembly 31 from the non-light restricting orientation of FIG. 7B to the light-restricting orientation of FIG. 7A (i.e., right-to-left motion of the first mechanism), objective housing 29 includes ramps 57 (see FIG. 5C), which guide pins 55 of moveable member 41. As shown in FIG. 5C, ramps 57 are preferably stepped. By means of these ramps, pins 55 move in grooves 53 and contact rails 51 to force the aperture assembly downward towards its light-restricting orientation as the first mechanism moves from right-to-left in going from FIG. 7B to FIG. 7A.

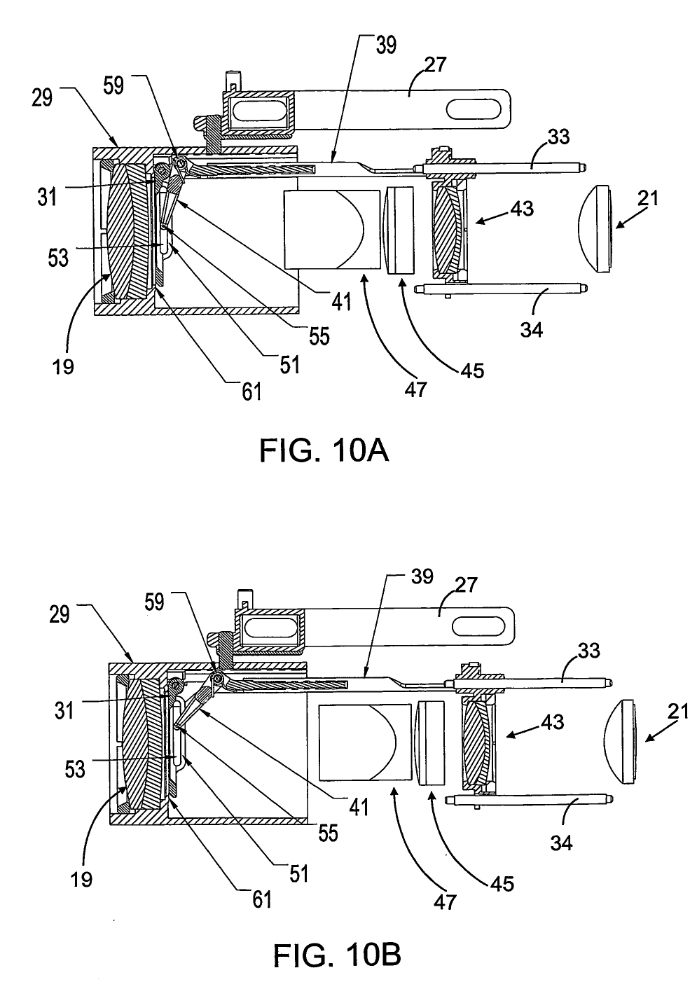

In addition to ramps 57, as can be seen most clearly in FIGS. 6A and 6B (see also FIGS. 10A and 10B), the first mechanism includes a torsion spring 59 between moveable member 41 and transport slide 39. This spring urges clockwise motion of the moveable member relative to the transport slide. When the aperture assembly 31 is in its light-restricting orientation, this clockwise urging keeps that assembly in contact with diaphragm 61 of objective housing 29, i.e., it biases the aperture assembly towards its light-restricting orientation. When the aperture assembly 31 is in its non-light restricting orientation, this clockwise urging keeps that assembly out off the light path through the binoculars, i.e., it biases the aperture assembly towards its non-light restricting orientation. Thus, in both orientations, torsion spring 59 helps the system remain securely in its resting orientations/positions. The spring switches between these functions at about the 45° position for the aperture assembly.

The first mechanism of FIG. 7 is transferred between its first (low magnification) and second (high magnification) rest positions by a combination of forces provided by the second and third mechanisms of FIGS. 8 and 9, respectively.

Beginning with FIG. 9, this figure shows the main input of transfer force to the drive system for the aperture assembly. As shown in this figure, the third mechanism comprises: toggle switch 17 and force transfer member 62 which includes a pin on its distal side (not shown) which is received in aperture 71 of input coupler 64 of the first mechanism. Toggling of switch 17 causes force transfer member 62 to apply force to the inside walls of aperture 71 which in turn causes input coupler 64 and thus the first mechanism to move. Although two apertures 71 and two force transfer members 62 could be used if desired, i.e., one set for each barrel, in practice, it is preferred to connect the input couplers 64 for the two barrels together and use a single aperture 71 and a single force transfer member 62 to move both input couplers simultaneously.

As shown in FIG. 9, force linkage assembly 85 is used for this purpose. In particular, this linkage provides simultaneous motion of left input coupler 64 based on the motion of right input coupler 64. As shown in FIG. 9, the linkage includes a central wall 85a surrounded by outer walls 85b and 85c which form a U-shaped receptacle which receives the central wall. The central wall can be carried by, for example, the right input coupler and the outer walls by the left input coupler. This arrangement can, of course, be reversed if desired. Similarly, force linkage assemblies having different structures can be used in the practice of the invention. Preferably, whatever mechanism is used allows for some freedom of motion between the mechanisms of the right and left barrels of the binocular to take account of manufacturing variability and to permit ready assembly of the overall system.

It should be noted that because only one force transfer member 62 and one aperture 71 are used, the third mechanisms for the right and left barrels of the binocular have different structures. Thus, the third mechanism for the right barrel includes toggle switch 17, force transfer member 62, and aperture 71, while that for the left barrel includes those three elements plus a portion of the right side input coupler 64 and force linkage assembly 85. However constructed, the third mechanisms for the right and left barrels will preferably share at least one common element to ensure the first mechanisms of those barrels move simultaneously.

Returning to FIG. 9, as shown in that figure, force transfer member 62 is pivoted on pin 63 carried by toggle switch housing 65 and includes an internal pin 67 which engages a U-shaped recess 69 formed in the toggle switch. The toggle switch itself is pivoted about pin 83. To provide a range of free movement between the third mechanism, on one hand, and the first mechanism, on the other, e.g., a range of free movement which, among other things, accommodates manufacturing tolerances, force transfer member 62 is not rigidly attached to input coupler 64 but rather includes a pin (not shown) that rides in aperture 71 formed in that coupler. The range of free movement provided by aperture 71 can be, for example, approximately 1.0 millimeter. As noted above, a further (generally smaller) free range of motion is provided by force linkage assembly 85.

To provide fast and reliable switching between the low magnification and high magnification settings of the binocular, the main force input mechanism of FIG. 9 (third mechanism) is supplemented with a spring-based system illustrated in FIG. 8 (second mechanism). This system employs a spring 73 (the “over-the-center” spring) which biases the transport slide 39 into either its first (low magnification) rest position (FIG. 8A) corresponding to the light-restricting orientation of the aperture assembly or its second (high magnification) rest position (FIG. 8B) corresponding to the non-light restricting orientation of the aperture assembly.

Over-the-center spring 73 also causes the transport slide to automatically switch to its first (low magnification) rest position once the slide has moved past a first position (high magnification to low magnification transition position) along its path of motion towards the first (low magnification) rest position. It further causes the slide to automatically switch to its second (high magnification) rest position once the slide mechanism has moved past a second position (low magnification to high magnification transition position) along its path of motion towards the second (high magnification) rest position.

In particular, if the total length of the path of motion of the transport slide is L, then the first position (high magnification to low magnification transition position) is preferably at least two-thirds of L in the direction of the first (low magnification) rest position. Similarly, the second position (low magnification to high magnification transition position) is preferably at least two-thirds of L in the direction of the second rest (high magnification) position. That is, once the user has activated toggle switch 17 to an extent which causes force transfer member 62 to move the input couplers 64 of the two barrels by, for example, 75% of their total movement, then irrespective of manufacturing errors, transport slides 39 of the two barrels will always have moved two-thirds of their total travel L, whereupon the over-the-center spring 73 will take over and complete the motion every time.

It should be noted that in moving toggle switch 17, the user must overcome a resisting force (the biasing force) provided by the over-the-center spring. Accordingly, the strength of this spring needs to be selected with this in mind. More particularly, since each barrel will include a spring 73, the strength of the spring needs to be selected so that the user will be able to readily overcome the strength of two springs when activating toggle 17.

In selecting spring strengths (spring rates), it should be noted that the force exerted by torsion spring 59 must be overcome in switching from the high magnification setting to the low magnification setting of the binocular. This force is not constant over the path of motion between these settings, but rather is small at the beginning of the motion, increases in the middle (i.e., as pins 55 engage and ride over ramps 57), and is again small at the end of the path of motion. Whereas the force of torsion spring 59 needs to be overcome in moving from the high magnification to the low magnification setting, it is not a significant factor in moving in the opposite direction, i.e., from the low magnification setting to the high magnification setting, and indeed, if anything, will tend to facilitate that motion.

The over-the-center spring preferably comprises a torsion spring having first and second ends each of which comprises a loop 79. One of the loops is rotatably mounted on a pin 75 (the “input pin”) associated with the transport slide, e.g., located on lens carrier 35 or bushing 37, and the other loop is rotatably mounted on a fixed pin 77, i.e., a pin which is stationary with respect to the binocular's housing, e.g., a pin affixed to or part of the binocular's housing. In this way, as shown in FIGS. 8A and 8B, the over-the-center spring can rotate and swing back and forth over a portion of the transport slide as the aperture assembly is transferred between its light-restricting orientation (FIG. 8A) and its non-light restricting orientation (FIG. 8B). To facilitate that motion, transport slide 39 preferably comprises a recess 81 through which the main coil of the over-the-center spring passes as the transport slide moves between its rest positions.

In summary, the second and third mechanisms operate together as follows. Initially the forces provided by the force transfer member 62 of the third mechanism and the over-the-center spring 73 of the second mechanism oppose each other. However, once the main coil of the over-the-center spring passes through recess 81 of transport slide 39, the forces from the force transfer member and the over-the-center spring become additive. Shortly thereafter, the over-the-center spring takes over and controls the movement of the first mechanism, with the force transfer member 62 thereupon becoming effectively disengaged from the first mechanism as result of the presence of the free connection at aperture 71. In particular, aperture 71 allows the over-the-center springs to move transport slides 39 of the two barrels and thus their input couplers 64 relative to the force transfer member.

To avoid binding, input coupler 64, which receives input force from the toggle switch, and pin 75, which receives input force from over-the-center spring, preferably are located within the same quadrant of guide shaft 33. FIG. 8C illustrates a preferred configuration for the relationship between the input coupler 64, pin 75, and bushing 37 which minimizes the chances that bushing 37 will bind on shaft 33. As shown in this figure, the forces applied to the bushing from the pin and the input coupler are within the same half-quadrant of the shaft, as is most preferred.

Although an aperture assembly which remains in one position as the binocular is focused can be used in the practice of the invention, such a system will result in changes in the brightness of the image seen by the user as focusing takes place. To avoid such a change in brightness, it is preferred for the aperture assembly to move with the objective of the binocular during focusing. FIGS. 10A and 10B illustrate that torsion spring 59, moveable member 41, and the ability of pins 55 to move in grooves 53 formed by rails 51 automatically achieve this result. In particular, FIG. 10A shows the aperture assembly in its light-restricting orientation for a far focus adjustment, while FIG. 10B shows the aperture assembly in its light-restricting orientation for a near focus adjustment. The movement of pins 55 in grooves 53 and the change in angle between moveable member 41 and transport slide 39 is evident in these figures. In each case, the aperture assembly is fully seated in diaphragm 61 of objective housing 29, as is desired.

In the embodiment of FIGS. 3-10, aperture 32 has a constant diameter and is moved into and out of the light path through the binocular. Other approaches can be used in the practice of the invention. As just one example, two half diaphragm elements which slide forward within the binocular's barrel and rotate inward towards the optical axis as they move forward can be used to form the aperture stop in the low magnification position. Tracks, cams, and/or ramps formed and/or attached to the inside surface of the binocular's barrel and/or to the mounting structure for the binocular's lens elements can be used to achieve this motion. The forward plus inward movement allows the barrel of the binoculars to have a small outside diameter while still providing a variable aperture stop.

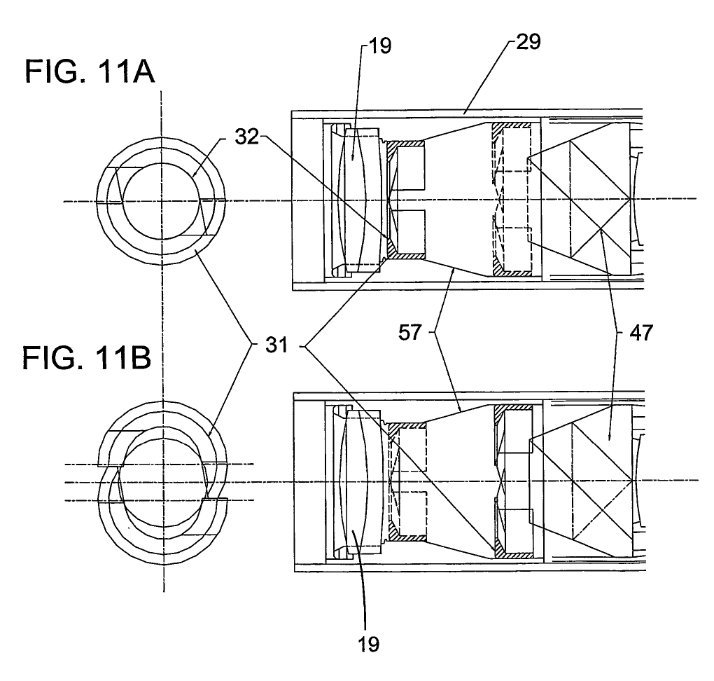

FIG. 11 shows a mechanism of this type. In particular, FIG. 11A shows the mechanism in its low magnification position, while FIG. 11B shows the high magnification position. In each case, both the low magnification and high magnification positions are shown in the right hand portions of the figure, with the low magnification position being shown solid and the high magnification position shown dashed in FIG. 11A and the high magnification position shown solid and the low magnification position shown dashed in FIG. 11B. The circular aperture of the low magnification position is shown in both of the left hand portions of the figure, with the inner edges of the half diaphragm elements being at the circular aperture in FIG. 11A and moved away from the circular aperture in FIG. 11B.

In operation, moveable aperture assembly 31 of FIG. 11 rides on ramp 57 which is formed as part of objective housing 29. This ramp guides the movement of the aperture assembly between its light restricting orientation of FIG. 11A and its non-light restricting orientation of FIG. 11B.

From the foregoing, it can be seen that the various preferred features of the invention include:

(a) the optical system's aperture stop is constrained to be on the image side (eyepiece side) of the objective and, in particular, is constrained to be in this location when the binocular is in its low magnification position;

(b) a physical aperture stop is only used for the low magnification position of the binocular;

(c) the objective performs the function of an aperture stop in the high magnification position; and/or

(d) the diameter of the system's exit pupil is kept substantially constant for the high and low magnification positions.

Although specific embodiments of the invention have been described and illustrated, it is to be understood that modifications can be made without departing from the invention's spirit and scope. For example, although the invention has been described primarily in terms of a binocular, it is equally applicable to a monocular.

Similarly, although optical systems having all of the foregoing features are preferred, it is to be understood that the various aspects of the invention need not be all used together. That is, in practice, each of the aspects of the invention can be used separately or in combination with some or all of the other aspects.

Further, the prescriptions of Tables 1-1, 1-2, and 2 are merely representative prescriptions and are not intended to limit the scope of the invention. Thus, the features of the invention illustrated in these tables can be put into practice in optical systems having a variety of other prescriptions that can be readily developed by persons skilled in the art from the present disclosure. Similarly, the mechanical systems shown in the figures are representative mechanisms and a variety of other mechanisms can be readily developed by persons skilled in the art from the present disclosure.

TABLE 1-1
System/Prescription Data
SURFACE DATA SUMMARY:

| Surf | Radius | Thickness | Glass | Diameter | Conic |
|---|---|---|---|---|---|
| OBJ | Infinity | Infinity | | 0 | 0 |
| 1 | 59.3779 | 5.5 | BK7 | 25 | 0 |
| 2 | −59.3779 | 3 | SF4 | 25 | 0 |
| 3 | −150.6326 | 30.86342 | | 25 | 0 |
| 4 | Infinity | 75 | BK7 | 17 | 0 |
| 5 | Infinity | 0.65 | | 17 | 0 |
| 6 | 41.09405 | 2.80883 | SF6 | 17 | 0 |
| 7 | −31.60547 | 1 | LAK8 | 17 | 0 |
| 8 | 19.40518 | 5.622095 | | 15.2 | 0 |
| 9 | 42.84257 | 3.675603 | LAK8 | 16.44 | 0 |
| 10 | −18.67626 | 1 | SF6 | 16.44 | 0 |
| 11 | −38.88099 | 23.67654 | | 16.44 | 0 |
| 12 | 11.02612 | 2 | PMMA | 14.03644 | −1.178465 |
| 13 | 10.89626 | 0.9282009 | | 13.4 | 0 |
| 14 | 11.91994 | 3.526014 | SK2 | 13.4 | 0 |
| 15 | −100.3734 | 12 | | 13.4 | 0 |
| STO | — | 18.75 | | 3 | — |
| IMA | −52.5 | | | 14.51812 | 0 |

MULTI-CONFIGURATION DATA:

| | Configuration A | Configuration B |
|---|---|---|
| Thickness 8: | 5.622095 | 25.90834 |
| Thickness 11: | 23.67654 | 3.390295 |
| Exit Pupil Dia: | 3 | 2.5 |

INDEX OF REFRACTION DATA:

| Surf | Glass | 0.486133 | 0.587562 | 0.656273 |
|---|---|---|---|---|
| 0 | | 1.00000000 | 1.00000000 | 1.00000000 |
| 1 | BK7 | 1.52237629 | 1.51680003 | 1.51432235 |
| 2 | SF4 | 1.77468086 | 1.75520125 | 1.74729815 |
| 3 | | 1.00000000 | 1.00000000 | 1.00000000 |
| 4 | BK7 | 1.52237629 | 1.51680003 | 1.51432235 |
| 5 | | 1.00000000 | 1.00000000 | 1.00000000 |
| 6 | SF6 | 1.82775211 | 1.80518208 | 1.79609194 |
| 7 | LAK8 | 1.72221895 | 1.71300317 | 1.70897389 |
| 8 | | 1.00000000 | 1.00000000 | 1.00000000 |
| 9 | LAK8 | 1.72221895 | 1.71300317 | 1.70897389 |
| 10 | SF6 | 1.82775211 | 1.80518208 | 1.79609194 |
| 11 | | 1.00000000 | 1.00000000 | 1.00000000 |
| 12 | PMMA | 1.49776072 | 1.49175571 | 1.48919963 |
| 13 | | 1.00000000 | 1.00000000 | 1.00000000 |
| 14 | SK2 | 1.61485707 | 1.60738097 | 1.60413545 |
| 15 | | 1.00000000 | 1.00000000 | 1.00000000 |
| 16 | | 1.00000000 | 1.00000000 | 1.00000000 |
| 17 | | 1.00000000 | 1.00000000 | 1.00000000 |

TABLE 1-2
System/Prescription Data
SURFACE DATA SUMMARY:

| Surf | Radius | Thickness | Glass | Diameter | Conic |
|---|---|---|---|---|---|
| OBJ | Infinity | Infinity | | 0 | 0 |
| 1 | 58.55938 | 5.5 | BK7 | 25 | 0 |
| 2 | −58.55938 | 3 | SF4 | 25 | 0 |
| 3 | −147.8761 | 28.15906 | | 25 | 0 |
| 4 | Infinity | 75 | BK7 | 19.38982 | 0 |
| 5 | Infinity | 0.65 | | 15.8884 | 0 |
| 6 | 42.06329 | 3.8 | SF6 | 15.89604 | 0 |
| 7 | −30.64732 | 1 | LAK8 | 15.55596 | 0 |
| 8 | 18.95255 | 26.27005 | | 14.84117 | 0 |
| 9 | 42.746 | 4.6 | LAK8 | 16.14615 | 0 |
| 10 | −18.79364 | 1 | SF6 | 16.12432 | 0 |
| 11 | −39.30699 | 3.415926 | | 16.19464 | 0 |
| 12 | 11.07818 | 2 | PMMA | 14.36807 | −1.206328 |
| 13 | 10.73653 | 0.4600734 | | 13.52872 | 0 |
| 14 | 11.41979 | 4.4 | SK2 | 13.58497 | 0 |
| 15 | −126.3062 | 12 | | 12.72739 | 0 |
| STO | — | 10 | | 2.5 | — |
| IMA | −28 | | | 7.923071 | 0 |

MULTI-CONFIGURATION DATA:

| | Configuration A | Configuration B |
|---|---|---|
| Thickness 8: | 5.772192 | 26.27005 |
| Thickness 11: | 23.91379 | 3.415926 |
| Exit Pupil Dia: | 3.0 | 2.5 |

INDEX OF REFRACTION DATA:

| Surf | Glass | 0.486133 | 0.587562 | 0.656273 |
|---|---|---|---|---|
| 0 | | 1.00000000 | 1.00000000 | 1.00000000 |
| 1 | BK7 | 1.52237629 | 1.51680003 | 1.51432235 |
| 2 | SF4 | 1.77468086 | 1.75520125 | 1.74729815 |
| 3 | | 1.00000000 | 1.00000000 | 1.00000000 |
| 4 | BK7 | 1.52237629 | 1.51680003 | 1.51432235 |
| 5 | | 1.00000000 | 1.00000000 | 1.00000000 |
| 6 | SF6 | 1.82775211 | 1.80518208 | 1.79609194 |
| 7 | LAK8 | 1.72221895 | 1.71300317 | 1.70897389 |
| 8 | | 1.00000000 | 1.00000000 | 1.00000000 |
| 9 | LAK8 | 1.72221895 | 1.71300317 | 1.70897389 |
| 10 | SF6 | 1.82775211 | 1.80518208 | 1.79609194 |
| 11 | | 1.00000000 | 1.00000000 | 1.00000000 |
| 12 | PMMA | 1.49776072 | 1.49175571 | 1.48919963 |
| 13 | | 1.00000000 | 1.00000000 | 1.00000000 |
| 14 | SK2 | 1.61485707 | 1.60738097 | 1.60413545 |
| 15 | | 1.00000000 | 1.00000000 | 1.00000000 |
| 16 | | 1.00000000 | 1.00000000 | 1.00000000 |
| 17 | | 1.00000000 | 1.00000000 | 1.00000000 |

TABLE 2
SURFACE DATA SUMMARY:

| Surf | Radius | Thickness | Glass | Diameter |
|---|---|---|---|---|
| OBJ | Infinity | Infinity | | 0 |
| 1 | 59.3779 | 5.5 | BK7 | 25 |
| 2 | −59.3779 | 3 | SF4 | 25 |
| 3 | −150.6326 | 31.44615 | | 25 |
| 4 | Infinity | 75 | BK7 | 16.73204 |
| 5 | Infinity | 0.65 | | 15.63388 |
| 6 | 41.09405 | 2.80883 | SF6 | 15.64341 |
| 7 | −31.60547 | 1 | LAK8 | 15.45974 |
| 8 | 19.40518 | 5.622095 | | 14.76661 |
| 9 | 42.84257 | 3.675603 | LAK8 | 15.9405 |
| 10 | −18.67626 | 1 | SF6 | 15.91785 |
| 11 | −38.88099 | 21.65279 | | 15.97029 |
| 12 | 40.93013 | 5 | F2 | 13.71167 |
| 13 | −9.557474 | 1 | SF11 | 13.4619 |
| 14 | −28.28454 | 0.5 | | 13.60053 |
| 15 | 11.2854 | 2 | F2 | 12.59989 |
| 16 | 25.72916 | 12 | | 12.06239 |
| STO | — | 18.75 | | 3 |
| IMA | −52.5 | | | 14.60573 |

MULTI-CONFIGURATION DATA:

| | Configuration A | Configuration B |
|---|---|---|
| Thickness 8: | 5.622095 | 23.87525 |
| Thickness 11: | 21.65279 | 4 |
| Aperture: | 3 | 2.5 |

INDEX OF REFRACTION DATA:

| Surf | Glass | 0.486133 | 0.587562 | 0.656273 |
|---|---|---|---|---|
| 0 | | 1.00000000 | 1.00000000 | 1.00000000 |
| 1 | BK7 | 1.52237629 | 1.51680003 | 1.51432235 |
| 2 | SF4 | 1.77468086 | 1.75520125 | 1.74729815 |
| 3 | | 1.00000000 | 1.00000000 | 1.00000000 |
| 4 | BK7 | 1.52237629 | 1.51680003 | 1.51432235 |
| 5 | | 1.00000000 | 1.00000000 | 1.00000000 |
| 6 | SF6 | 1.82775211 | 1.80518208 | 1.79609194 |
| 7 | LAK8 | 1.72221895 | 1.71300317 | 1.70897389 |
| 8 | | 1.00000000 | 1.00000000 | 1.00000000 |
| 9 | LAK8 | 1.72221895 | 1.71300317 | 1.70897389 |
| 10 | SF6 | 1.82775211 | 1.80518208 | 1.79609194 |
| 11 | | 1.00000000 | 1.00000000 | 1.00000000 |
| 12 | F2 | 1.63208146 | 1.62004014 | 1.61503169 |
| 13 | SF11 | 1.80645439 | 1.78471985 | 1.77598768 |
| 14 | | 1.00000000 | 1.00000000 | 1.00000000 |
| 15 | F2 | 1.63208146 | 1.62004014 | 1.61503169 |
| 16 | | 1.00000000 | 1.00000000 | 1.00000000 |
| 17 | | 1.00000000 | 1.00000000 | 1.00000000 |
| 18 | | 1.00000000 | 1.00000000 | 1.00000000 |

TABLE 3

| Number | Element |
|---|---|
| 5 | calculated location of aperture stop (low mag) |
| 6 | calculated location of aperture stop (high mag) |
| 7 | image surface |
| 9 | barrel |
| 11 | bridge |
| 13 | binocular |
| 15 | thumb wheel |
| 17 | toggle switch |
| 19 | objective |
| 21 | eyepiece |
| 23 | diopter adjustment |
| 25 | spiral cam |
| 27 | rail |
| 29 | objective housing |
| 31 | moveable aperture assembly |
| 32 | aperture |
| 33 | guide shaft |
| 34 | shaft |
| 35 | lens carrier |
| 37 | bushing |
| 39 | transport slide |
| 41 | moveable member |
| 43 | moveable lens assembly |
| 45 | fixed intermediate lens element |
| 47 | prism |
| 49 | pin |
| 51 | rail |
| 53 | groove |
| 55 | pin |
| 57 | ramp |
| 59 | torsion spring |
| 61 | diaphragm |
| 62 | force transfer member |
| 63 | pin |
| 64 | input coupler |
| 65 | toggle switch housing |
| 67 | internal pin |
| 69 | U-shaped recess |
| 71 | aperture |
| 73 | over-the-center spring |
| 75 | input pin |
| 77 | fixed pin |
| 79 | loop |
| 81 | recess in transport slide |
| 83 | toggle switch pin |
| 85 | force linkage assembly |
| 85a | central wall of force linkage assembly |
| 85b | outer wall of force linkage assembly |
| 85c | outer wall of force linkage assembly |

What is claimed is:

1. An optical system which transmits light and has first and second settings, the first setting providing a magnification M₁ and the second setting providing a magnification M₂, wherein:
(i) M₂/M₁>1.0;
(ii) said system has an exit pupil which has a diameter D₁ for the first setting and a diameter D₂ for the second setting;
(iii) D₁ and D₂ are substantially the same; and
(iv) the first and second settings are the only rest positions of the optical system.

2. The optical system of claim 1 wherein:
1.0<D₁/D₂<1.5.

3. An optical system which transmits light and has first and second settings, the first setting providing a magnification M₁ and the second setting providing a magnification M₂, wherein:
(i) M₂/M₁>1.0;
(ii) the first and second settings are the only rest positions of the optical system; and
(iii) the system comprises a two position aperture stop which restricts more light when the system is in the first setting than when the system is in the second setting.

4. The optical system of claim 3 wherein the two position aperture stop does not restrict light when the optical system is in the second setting.

5. The optical system of claim 3 wherein:
(i) the optical system has an exit pupil which has a diameter D₁ for the first setting and a diameter D₂ for the second setting; and
(ii) D₁ and D₂ are substantially the same.

6. The optical system of claim 5 wherein:
1.0<D₁/D₂<1.5.

7. The optical system of claim 3 wherein the optical system comprises an objective and an eyepiece and the two position aperture stop is located between the objective and the eyepiece and is closer to the objective than to the eyepiece.

8. A dual power binocular having an objective end and an eyepiece end, said binocular comprising two optical systems according to claim 1 or claim 3 and a switching mechanism which simultaneously switches the two systems between their two settings.

9. The dual power binocular of claim 8 wherein:
(i) the binocular further comprises a focusing system with a manual input;
(ii) the switching mechanism has a manual input; and
(iii) the manual input for the focusing system is closer to the objective end than the manual input for the switching mechanism.

10. The dual power binocular of claim 9 wherein the binocular comprises a bridge and both the manual input for the focusing system and the manual input for the switching mechanism are located on the bridge.

11. An optical system which transmits light, said system comprising:
(a) an aperture assembly comprising an aperture, said assembly having two orientations in one of which the aperture restricts the amount of light transmitted through the optical system (the light-restricting orientation) and in the other of which it does not restrict the amount of light transmitted through the optical system (the non-light restricting orientation);
(b) a first mechanism which moves the aperture assembly between the light-restricting and the non-light restricting orientations, said first mechanism having a path of motion which includes a first rest position corresponding to the light-restricting orientation and a second rest position corresponding to the non-light restricting orientation;
(c) a second mechanism comprising a spring which (1) is adapted to bias the first mechanism into either the first rest position or the second rest position, (2) causes the first mechanism to automatically switch to the first rest position once the first mechanism has moved past a first position along its path of motion, and (3) causes the first mechanism to automatically switch to the second rest position once the first mechanism has moved past a second position along its path of motion; and
(d) a third mechanism which:
(i) when the first mechanism is in its first rest position, is adapted to move the first mechanism between the first rest position and the second position; and
(ii) when the first mechanism is in its second rest position, is adapted to move the first mechanism between the second rest position and the first position.

12. The optical system of claim 11 wherein the first mechanism comprises a first pin, the system comprises a housing, the housing comprises a second pin, and the spring of the second mechanism is a torsion spring having first and second ends each of which comprises a loop, one loop being rotatably mounted on the first pin and the other loop being rotatably mounted on the second pin.

13. The optical system of claim 12 wherein the torsion spring comprises a main coil and the first mechanism comprises a recess through which the main coil passes as the first mechanism moves between its first and second rest positions.

14. The optical system of claim 11 wherein the first mechanism comprises a shaft and a bushing adapted to translate along the shaft and the second and third mechanisms apply forces to the bushing within the same quadrant of the shaft.

15. The optical system of claim 11 wherein in addition to the aperture assembly, the first mechanism moves a lens assembly.

16. The optical system of claim 15 wherein the movement of the lens assembly changes the magnification of the optical system.

17. The optical system of claim 11 wherein there is a range of free movement between the third mechanism and the first mechanism.

18. The optical system of claim 11 wherein the third mechanism is manually operated.

19. A binocular comprising two optical systems according to claim 11 wherein the third mechanisms of the two systems share at least one common element so as to ensure simultaneous movement of the first mechanisms of the systems along their paths of motion.

20. An optical system which transmits light comprising:
(a) a lens assembly which transmits light;
(b) a focusing system for moving the lens assembly to focus the optical system;
(c) an aperture assembly which receives light from the lens assembly, said aperture assembly comprising an aperture having two orientations in one of which the aperture restricts light transmission (the light-restricting orientation) and in the other of which it does not restrict light transmission (the non-light restricting orientation); and
(d) an aperture drive mechanism for transferring the aperture assembly between the two orientations; wherein when the focusing system moves the lens assembly, it also moves the aperture assembly but does not change the aperture assembly's orientation.

21. The optical system of claim 20 wherein the system comprises a diaphragm associated with the lens assembly and when the aperture assembly is in its light-restricting orientation, it contacts the diaphragm and remains in contact with the diaphragm as the focusing system moves the lens and aperture assemblies.

22. The optical system of claim 20 wherein the aperture drive mechanism comprises a moveable member which allows the aperture assembly to maintain its orientation as the focusing system moves the lens and aperture assemblies.

23. The optical system of claim 22 wherein the moveable member has a forked configuration which spans the aperture.

24. The optical system of claim 22 wherein as the focusing system moves the lens and aperture assemblies, the moveable member translates relative to the aperture assembly if the aperture assembly is in the non-light restricting orientation and the moveable member translates and rotates if the aperture assembly is in the light-restricting orientation.

25. The optical system of claim 22 wherein the aperture assembly comprises at least one groove and the moveable member comprises at least one pin which moves in the at least one groove.

26. The optical system of claim 22 wherein the aperture drive mechanism has a first rest position corresponding to the light-restricting orientation and a second rest position corresponding to the non-light restricting orientation, and the optical system further comprises a housing which comprises at least one ramp which engages the moveable member and guides that member so as to move the aperture assembly from the non-light restricting orientation to the light-restricting orientation as the aperture drive mechanism moves from its second rest position to its first rest position.

27. The optical system of claim 26 wherein the moveable member comprises at least one pin which engages the at least one ramp.

28. The optical system of claim 27 wherein the aperture assembly comprises at least one groove and the at least one pin of the moveable member rides in the at least one groove.

29. The optical system of claim 26 wherein the focusing system moves the housing and the housing carries the lens assembly.

30. The optical system of claim 29 wherein the aperture assembly is pivotally mounted to the housing.

31. The optical system of claim 20 wherein the aperture drive mechanism comprises a spring which, when the aperture assembly is in the light-restricting orientation, biases the aperture assembly towards said light-restricting orientation, and when the aperture assembly is in the non-light restricting orientation, biases the aperture assembly towards said non-light restricting orientation.

32. The optical system of claim 20 wherein the lens assembly comprises at least one objective lens element.

33. The optical system of claim 20 wherein the light-restricting orientation and the non-light restricting orientation are substantially perpendicular to one another.

34. A binocular comprising two optical systems according to claim 20, wherein the focusing systems of the two optical systems share at least one common element so as to ensure simultaneous focusing of the two optical systems and the aperture drive mechanisms of the two optical systems share at least one common element so as to ensure simultaneous transferring of the aperture assemblies of the two optical systems between their two orientations.

35. An optical system which transmits light comprising:
(a) an aperture assembly comprising an aperture, said assembly having two orientations in one of which the aperture restricts the amount of light transmitted through the optical system (the light-restricting orientation) and in the other of which it does not restrict the amount of light transmitted through the optical system (the non-light restricting orientation); and
(b) an aperture drive mechanism for transferring the aperture assembly between the two orientations, said mechanism comprising a spring which, when the aperture assembly is in the light-restricting orientation, biases the aperture assembly towards said light-restricting orientation, and when the aperture assembly is in the non-light restricting orientation, biases the aperture assembly towards said non-light restricting orientation.

36. A binocular comprising two optical systems according to claim 35, wherein the aperture drive mechanisms of the two optical systems share at least one common element so as to ensure simultaneous transferring of the aperture assemblies of the two optical systems between their two orientations.

37. An optical system which transmits light comprising:
(a) an aperture assembly comprising an aperture, said assembly having two orientations in one of which the aperture restricts the amount of light transmitted through the optical system (the light-restricting orientation) and in the other of which it does not restrict the amount of light transmitted through the optical system (the non-light restricting orientation);
(b) an aperture drive mechanism for transferring the aperture assembly between the two orientations, said aperture drive mechanism having a first rest position corresponding to the light restricting orientation and a second rest position corresponding to the non-light restricting orientation; and
(c) a housing which comprises at least one ramp which engages the aperture drive mechanism so as to guide the aperture assembly from the non-light restricting orientation to the light-restricting orientation as the aperture drive mechanism moves from its second rest position to its first rest position.

38. The optical system of claim 37 wherein the aperture drive mechanism comprises at least one pin which engages the ramp.

39. The optical system of claim 37 wherein the ramp is stepped.

40. A binocular comprising two optical systems according to claim 37, wherein the aperture drive mechanisms of the two optical systems share at least one common element so as to ensure simultaneous transferring of the aperture assemblies of the two optical systems between their two orientations.

41. An optical system which transmits light, said system having an exit pupil and comprising:
(a) a lens assembly which transmits light;
(b) a focusing system for moving the lens assembly to focus the optical system; and
(c) an aperture assembly which receives light from the lens assembly, said assembly having two settings which differ in the amount of restriction they provide for light transmitted through the optical system;
wherein when the focusing system moves the lens assembly, it also moves the aperture assembly so that the size of the exit pupil of the optical system remains substantially constant during focusing.

42. The optical system of claim 41 wherein in one of the settings the aperture assembly has an orientation that restricts the amount of light transmitted through the optical system (the light-restricting orientation) and in the other setting the aperture assembly has an orientation that does not restrict the amount of light transmitted through the optical system (the non-light restricting orientation).

43. A binocular comprising two optical systems according to claim 41, wherein the focusing systems of the two optical systems share at least one common element so as to ensure simultaneous focusing of the two optical systems.

44. The optical system of claim 1, 3, 11, 20, 35, 37, or 41 wherein:
(i) the system comprises a moveable lens assembly;
(ii) movement of the moveable lens assembly changes the magnification of the system; and
(iii) the moveable lens assembly comprises a doublet.

45. The optical system of claim 44 wherein:
(i) the system comprises an eyepiece; and
(ii) the eyepiece comprises an aspheric surface.

46. The optical system of claim 11, 20, 35, 37, or 42 wherein:
(i) for the light-restricting orientation, the optical system has a magnification M₁ and an exit pupil diameter D₁;
(ii) for the non-light restricting orientation, the optical system has a magnification M₂ and an exit pupil diameter D₂;
(iii) M₂/M₁>1.0; and
(iv) 1.0<D₁/D₂<1.5.

47. The optical system of claim 1, 3, or 46 wherein:
M₂/M₁>1.5.

48. The optical system of claim 1, 3, or 46 wherein:
(D₁·M₁)/(D₂·M₂)<1.0.

49. The optical system of claim 48 wherein:
(D₁·M₁)/(D₂·M₂)<0.75.

50. A method for switching an optical system between a lower magnification setting and a higher magnification setting comprising:
(a) providing a switching mechanism having a first rest position corresponding to the lower magnification setting and a second rest position corresponding to the higher magnification setting, said switching mechanism having a path of motion between said first and second rest positions; and
(b) providing automatic switching to the first rest position once the switching mechanism has moved past a first position along its path of motion and automatic switching to the second rest position once the switching mechanism has moved past a second position along its path of motion.

51. The method of claim 50 wherein the automatic switching is provided by a torsion spring.
